(19) United States
(12) Patent Application Publication
(10) Pub. No.: US 2016/0313942 A1
(43) Pub. Date: Oct. 27, 2016

(54) ELECTRONIC APPARATUS, METHOD, AND COMPUTER READABLE MEDIUM

(71) Applicant: FUJITSU LIMITED, Kawasaki-shi (JP)

(72) Inventor: Masaaki NORO, Kawasaki (JP)

(73) Assignee: FUJITSU LIMITED, Kawasaki-shi (JP)

(21) Appl. No.: 15/073,797

(22) Filed: Mar. 18, 2016

(30) Foreign Application Priority Data
Apr. 22, 2015 (JP) 2015-087950

(51) Int. Cl. G06F 3/06; G06F 1/32

(52) U.S. Cl. CPC G06F 3/0625; G06F 1/3234; G06F 3/0631; G06F 3/0673

(57) ABSTRACT

An electronic apparatus includes a memory, a first device, and a processor that operates in an active mode and a standby mode. The processor is configured to determine whether the first device is of a first type that operates in a period in which the processor is in the standby mode, allocate a first region of the memory for the first device when the first device is determined to be of the first type, and control, while the processor is operated in the standby mode, the first region to be operated in a first mode and a second region of the memory to be operated in a second mode, the first mode being a mode with which the first region is usable by the first device, and the second mode being a mode with which an electrical power consumption is lower than that of the first mode.

### CROSS-REFERENCE TO RELATED APPLICATIONS

This application is based upon and claims the benefit of priority of the prior Japanese Patent Application No. 2015-087950, filed on Apr. 22, 2015, the entire contents of which are incorporated herein by reference.

### FIELD

The embodiments discussed herein are related to an electronic apparatus, a method, and a computer readable medium.

### BACKGROUND

A technique of achieving a reduced electrical power consumption has been developed for a battery-driven electronic apparatus, including a mobile communication terminal device such as a smartphone and a wearable device attachable to part of a human body. In an example control method, a processor, such as a central processing unit (CPU) mounted on a smartphone or a wearable device, is operated in a standby mode in a period in which data processing may not be performed, and the processor is activated and transitioned to an active mode when a condition is met to perform data processing. After performing desired data processing in the active mode, the processor transitions back to the standby mode when there is no data to be processed. In this manner, the processor is operated in the standby mode in a period in which the processor does not have to perform data processing, thereby achieving a reduced electrical power consumption of the processor.

A more specific example assumes that the wearable device cooperates with the smartphone, and when the smartphone receives an electronic mail, the wearable device notifies a user of this reception of the electronic mail through vibration, for example. In this example, the processor of the wearable device is operated in the standby mode to achieve a reduced electrical power consumption, whereas a wireless device mounted on the wearable device is controlled in the active mode to receive the notification from the smartphone. In this state, the smartphone notifies the wearable device of the reception of an electronic mail through, for example, wireless communication, and the wearable device receives this notification from the smartphone through the wireless device. Upon reception of the notification by the wireless device, the processor is activated. This operation achieves a reduced electrical power consumption of the wearable device in a period in which the processor is not performing data processing.

An example of the conventional technique is disclosed in Japanese Laid-open Patent Publication No. 2013-131940.

### SUMMARY

According to an aspect of the invention, an electronic apparatus includes a memory, a first device, and a processor that operates in an active mode and a standby mode. The processor is configured to determine whether the first device is of a first type that operates in a period in which the processor is in the standby mode, allocate a first region of the memory for the first device when the first device is determined to be of the first type, and control, while the processor is operated in the standby mode, the first region to be operated in a first mode and a second region of the memory to be operated in a second mode, the first mode being a mode with which the first region is usable by the first device, and the second mode being a mode with which an electrical power consumption is lower than that of the first mode.

The object and advantages of the invention will be realized and attained by means of the elements and combinations particularly pointed out in the claims.

It is to be understood that both the foregoing general description and the following detailed description are examples and explanatory and are not restrictive of the invention, as claimed.

### BRIEF DESCRIPTION OF DRAWINGS

FIG. 1 illustrates an example electronic apparatus;

FIG. 2 is a hardware configuration diagram of the electronic apparatus;

FIG. 3 illustrates change of electrical power consumption of the electronic apparatus;

FIG. 4 is a functional block diagram of a processor according to a first embodiment of the present disclosure;

FIG. 5 is a functional block diagram of a device managing unit according to the first embodiment;

FIG. 6 illustrates device driver correspondence information according to the first embodiment;

FIG. 7 is a functional block diagram of a memory managing unit according to the first embodiment;

FIG. 8 illustrates device operation mode information according to the first embodiment;

FIG. 9 illustrates memory operation mode information according to the first embodiment;

FIG. 10 illustrates a memory region allocation according to the first embodiment;

FIG. 11 illustrates information on correspondence between addresses and operation modes of a memory according to the first embodiment;

FIG. 12 illustrates the process of the memory region allocation according to the first embodiment;

FIG. 13 illustrates hardware connection according to the first embodiment;

FIG. 14 illustrates correspondence between addresses and banks according to the first embodiment;

FIG. 15 illustrates correspondence between banks and operation modes of the memory according to the first embodiment;

FIG. 16 illustrates the configuration of a volatile memory according to the first embodiment;

FIG. 17 illustrates the process of an electrical power control according to the first embodiment;

FIG. 18 illustrates the process of an activation event reception according to the first embodiment;

FIG. 19 illustrates the process of an activation of a processor according to the first embodiment;

FIG. 20 is a functional block diagram of a memory managing unit according to a second embodiment of the present disclosure;

FIG. 21 is a functional block diagram of a device managing unit according to the second embodiment;

FIG. 22 illustrates the process of a memory region allocation according to the second embodiment;

FIG. 23 is a functional block diagram of the processor according to a third embodiment of the present disclosure;

FIG. 24 illustrates device operation mode information according to the third embodiment; and

FIG. 25 illustrates the process of a device attribute change according to the third embodiment.

### DESCRIPTION OF EMBODIMENTS

In a period in which a processor of an electronic apparatus is in a standby mode, part of the electronic apparatus, such as a wireless device, maintains its operation in an active mode to enable reception of a notification that triggers an activation of the processor from another electronic apparatus. Thus, a certain amount of electrical power is consumed in a period in which the processor operates in a standby mode.

One aspect of the present embodiment achieves a reduced electrical power consumption by other devices and memories included in the electronic apparatus in a period in which the processor of the electronic apparatus operates in the standby mode.

### First Embodiment

The present embodiment achieves a reduced electrical power of a volatile memory included in the electronic apparatus in a period in which the processor of the electronic apparatus operates in the standby mode. Any device included in the electronic apparatus, such as the wireless device, is maintained in the active mode to receive an external signal, for example, that triggers an activation of the processor in a period in which the processor operates in the standby mode. The volatile memory is maintained in an accessible state to allow the wireless device to, for example, store a received signal therein. Maintaining the entire volatile memory mounted on the electronic apparatus in an accessible state results in an increased electrical power consumption of the volatile memory, and thus an increased electrical power consumption of the entire electronic apparatus. The present embodiment operates a memory region in the entire region of the volatile memory, in an accessible state, where the memory region is used by a device that maintains its operation in a period in which the processor is in the standby mode. On the other hand, the present embodiment operates, in a low electrical power consumption mode, a memory region used by a device that does not operate or operates in the low electrical power consumption mode in a period in which the processor is in the standby mode. This achieves a reduced electrical power consumption of the volatile memory in a period in which the processor operates in the standby mode.

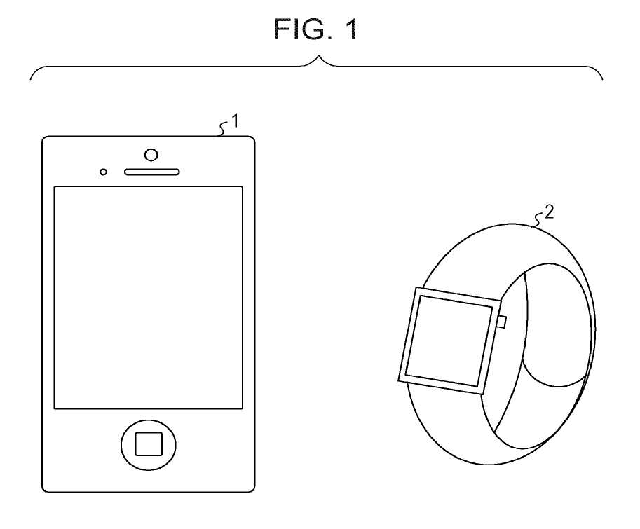

FIG. 1 illustrates an example electronic apparatus. FIG. 1 illustrates the appearances of a communication terminal apparatus 1 such as a smartphone, and a wearable device 2. The communication terminal apparatus 1 may be a mobile terminal apparatus other than a smartphone, a tablet personal computer (PC), and a personal digital assistant (PDA). The following description is made on the communication terminal apparatus 1 as an example electronic apparatus.

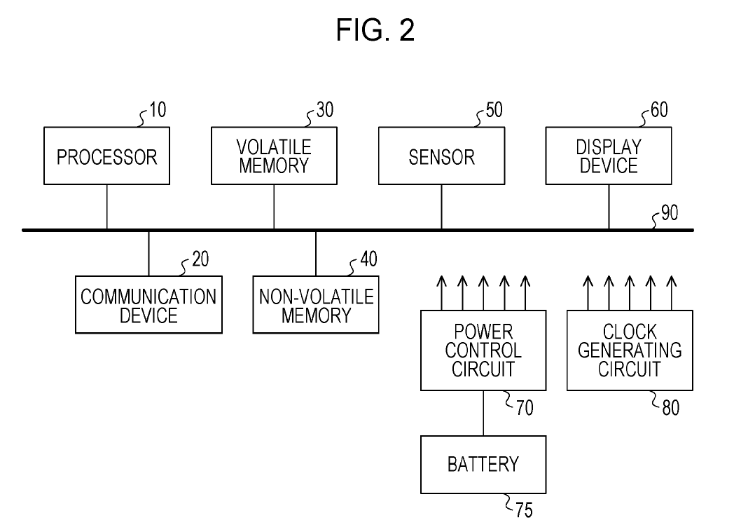

FIG. 2 is a hardware configuration diagram of the communication terminal apparatus 1. The communication terminal apparatus 1 includes a processor 10, a communication device 20, a volatile memory 30, a non-volatile memory 40, a sensor 50, a display device 60, a power control circuit 70, a battery 75, a clock generating circuit 80, and a bus 90. In the present specification, the communication device 20, the non-volatile memory 40, the sensor 50, and the display device 60 are each also referred to as a “device”.

The processor 10 performs, for example, a control of the entire communication terminal apparatus 1 and data processing. When not performing data processing, the processor 10 may set its operation mode to a standby mode. The standby mode is an operation mode having an electrical power consumption lower than that in an active mode in which the processor 10 performs data processing. The lower electrical power consumption is achieved by, for example, reducing an operation clock frequency as compared to that in the active mode, stopping supply of the operation clock frequency to the processor 10, reducing an operation voltage of the processor 10 as compared to that in the active mode, or stopping electrical power supply to the processor 10. In contrast to this low-voltage mode, the active mode is an operation mode in which the processor 10 operates at a power voltage higher than the low-voltage mode. The operation voltage of the processor 10 in the active mode is, for example, an operation voltage (rated voltage) defined for the processor 10 with its specifications to perform a normal operation.

The following description in the present specification is made on, as an example of the standby mode, the low-voltage mode in which the processor 10 operates at a power voltage lower than that in the active mode. In the low-voltage mode, although the processor 10 stops data processing, a time for a return to the active mode is short as compared to a mode in which electrical power supply is stopped. The processor 10 is an electronic circuit component such as a CPU, a micro control unit (MCU), a micro-processing unit (MPU), a digital signal processor (DSP), or a field-programmable gate array (FPGA).

The communication device 20 performs data communication with information processing apparatuses such as other communication terminal apparatuses and servers. This data communication may be wireless or wired communication. For the wireless communication, the communication device 20 includes, for example, a wireless circuit, a baseband circuit, an amplification circuit, and an antenna. The communication device 20 generates an activation signal that activates the processor 10 operating in the low-voltage mode. For example, having received an electronic mail from another communication terminal device while the processor 10 operates in the low-voltage mode, the communication device 20 writes desired data to the volatile memory 30 before transmitting the activation signal to the processor 10. The communication device 20 includes a MCU having, for example, a built-in static random access memory (SRAM). The MCU provided to the communication device 20 has an access to a particular region of the volatile memory 30 while the processor 10 operates in the low-voltage mode. The processor 10 shifts its operation mode from the low-voltage mode to the active mode in response to the activation signal received from the communication device 20. In the following description of the present specification, among signals received by the communication device 20 from outside, a signal serving as a trigger that switches the operation mode of the processor 10 from the low-voltage mode to the active mode is referred to as an “activation event”. In the present specification, an “event” refers not only to a signal received from outside of the communication terminal apparatus 1, but also to a notification signal generated inside the communication terminal apparatus 1, and a notification signal that does not activate the processor 10 in the standby mode.

The volatile memory 30 stores data used by the processor 10 to perform predetermined data processing, and results of data processing. A computer program to be executed by the processor 10 is loaded onto the volatile memory 30 from the non-volatile memory 40. Moreover, a particular region of the volatile memory 30 is used to store data of predetermined processing performed by a device, such as the communication device 20, mounted on the communication terminal apparatus 1. The volatile memory 30 is an electronic circuit component such as a dynamic random access memory (DRAM) or an SRAM. The present embodiment describes an example in which the volatile memory 30 is a DRAM. The volatile memory 30 includes a plurality of memory regions and is capable of switching each memory region among an operational mode that allows access such as writing and reading of data, a self-refresh mode that does not allow the access but allows a refresh operation while maintaining previously written data, and a clock gating mode that does not allows the access nor the refresh operation. The volatile memory 30 has decreasing electrical power consumption in order of the operational mode, the self-refresh mode, and the clock gating mode. Other operation modes such as an operation mode with a reduced power potential and an operation mode with stopped electrical power supply may be used as operation modes for each memory region of the volatile memory 30 in place of the self-refresh mode and the clock gating mode.

The non-volatile memory 40 stores, for example, a computer program to be executed by the processor 10. The non-volatile memory 40 is an electronic circuit component such as a mask read only memory (mask ROM), a programmable ROM (PROM), or a flash memory.

The sensor 50 is a GPS, an acceleration sensor, a wireless device for near field communication (NFC), or a wireless device for Bluetooth (registered trademark).

The display device 60 is, for example, a display, and has any function of an input device when the display has a touch panel function.

The communication device 20, the non-volatile memory 40, the sensor 50, and the display device 60 may be each controlled in, in addition to an active mode in which any function of the device is executed, a standby mode and a pause mode to achieve a reduced electrical power consumption. In the present embodiment, description is made with, as the standby mode, a low-voltage mode in which the device operates at a power voltage lower than that in the active mode, and with, as the pause mode, a power-off mode in which electrical power supply to the device is stopped. The present embodiment assumes that, when the processor 10 operates in the low-voltage mode, the communication device 20 maintains the active mode, the non-volatile memory 40 and the sensor 50 are controlled in the low-voltage mode, the display device 60 is controlled in the power-off mode.

The power control circuit 70 distributes electrical power supplied from the battery 75 to the processor 10 and the devices. The power control circuit 70 also controls electrical power to each device based on an instruction from the processor 10 so as to achieve a reduced electrical power consumption of the communication terminal apparatus 1. The power control circuit 70 is, for example, a direct current-direct current (DC-DC) conversion circuit. The battery 75 is the supply source of electrical power supplied to circuits such as the processor 10 and the devices in the communication terminal apparatus 1, and is a lithium-ion battery, for example.

The bus 90 connects, for example, the processor 10, the communication device 20, the volatile memory 30, the non-volatile memory 40, the sensor 50, and the display device 60, and functions as a data transmission path therebetween.

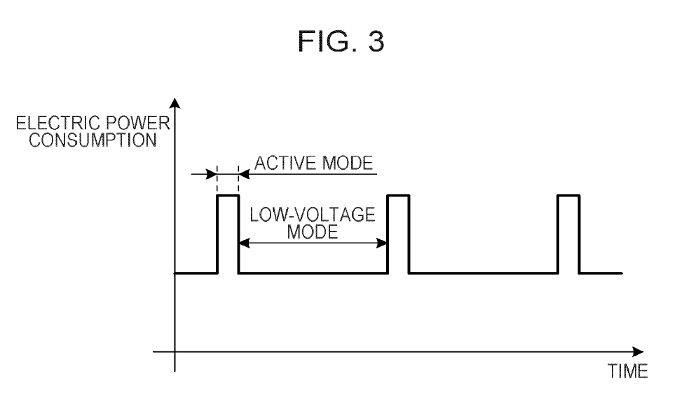

FIG. 3 illustrates electrical power consumption of the communication terminal apparatus 1. The horizontal axis represents time, and the vertical axis represents the electrical power consumption. As illustrated in FIG. 3, the communication terminal apparatus 1 operates in a period in which the processor 10 operates in the active mode, and a period in which the processor 10 operates in the low-voltage mode. Electrical power consumption in a period in which the processor 10 operates in the low-voltage mode is lower than that in a period in which the processor 10 operates in the active mode. This achieves a reduced electrical power consumption as compared to a case of continuously operating the processor 10 in the active mode. The technique disclosed in the present embodiment achieves a reduced electrical power consumption of the communication terminal apparatus 1 in a period in which the processor 10 operates in the low-voltage mode.

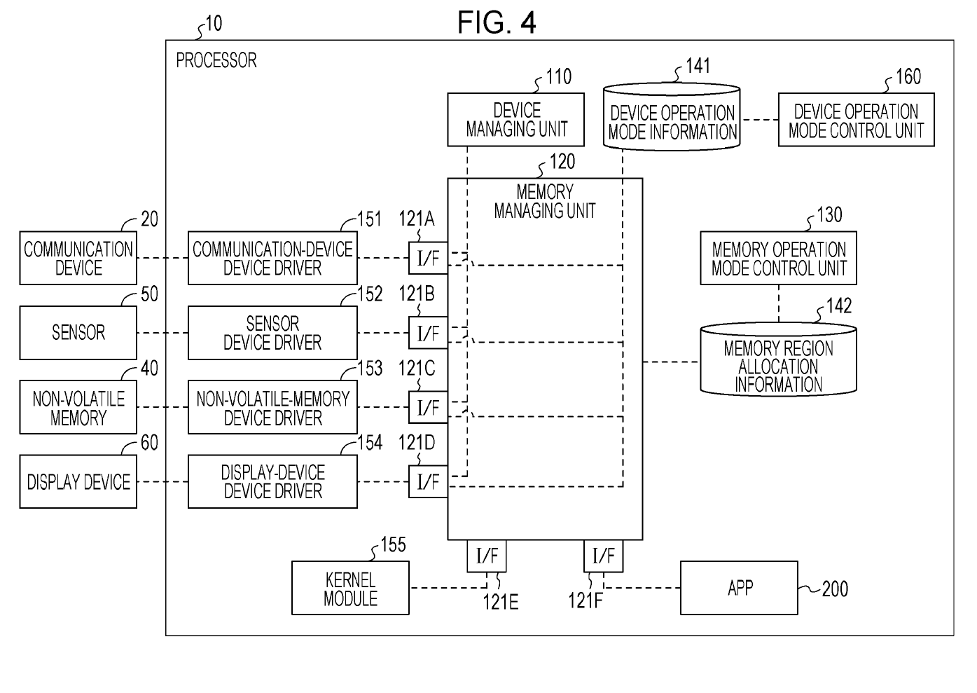

FIG. 4 illustrates relations between functional blocks achieved by the processor 10 and the devices included in the communication terminal apparatus 1. The “devices included in the communication terminal apparatus 1” are not necessarily limited to devices contained in a housing of the communication terminal apparatus 1, but include a device externally connected with the communication terminal apparatus 1, and a device that cooperates with the communication terminal apparatus 1 through wireless connection. The processor 10 achieves each functional block illustrated in FIG. 4 by executing, for example, a computer program loaded onto the volatile memory 30. The processor 10 functions as a device managing unit 110, a memory managing unit 120, a memory operation mode control unit 130, a communication-device device driver 151, a sensor device driver 152, a non-volatile-memory device driver 153, a display-device device driver 154, a kernel module 155, and a device operation mode control unit 160. The memory managing unit 120 includes interfaces (abbreviated as I/F in FIG. 4) 121A, 121B, 121C, 121D, 121E, and 121F that each receive a memory region acquisition request. The processor 10 holds device operation mode information 141 and memory region allocation information 142. The processor 10 functions as an app 200 by executing an application program. In FIG. 4, functional blocks other than the app 200 are achieved by, for example, the kernel of an operating system (OS). In the present embodiment, the kernel module 155 refers to a kernel module other than the device drivers, and an example of the kernel module 155 is a file system.

The device managing unit 110 searches for the devices included in the communication terminal apparatus 1, which are the communication device 20, the non-volatile memory 40, the sensor 50, and the display device 60 in FIG. 4. The communication-device device driver 151, the sensor device driver 152, the non-volatile-memory device driver 153, and the display-device device driver 154 are device drivers for the communication device 20, the non-volatile memory 40, the sensor 50, and the display device 60, respectively. The memory managing unit 120 is provided with the interfaces 121A, 121B, 121C, and 121D for the communication-device device driver 151, the sensor device driver 152, the non-volatile-memory device driver 153, and the display-device device driver 154. Each device driver issues a memory region acquisition request to the corresponding one of the interfaces 121A, 121B, 121C, and 121D. The memory managing unit 120 is provided with the interfaces 121E and 121F for the kernel module 155 and the app 200. Each of the kernel module 155 and the app 200 issues a memory region acquisition request to the corresponding one of the interfaces 121E and 121F.

In response to a memory region acquisition request received through the interface 121A, 121B, 121C, 121D, 121E, or 121F, the memory managing unit 120 allocates a particular region of the volatile memory 30 based on the attribute of the requestor of the memory region acquisition request by referring to the device operation mode information 141. Specific contents of the device operation mode information 141 and this memory region allocation based on the attribute of the requestor of the memory region acquisition request are described later. The memory managing unit 120 notifies the requestor of the memory region acquisition request of a result of the memory region allocation. The memory managing unit 120 also records the result of the memory region allocation in the memory region allocation information 142. The memory operation mode control unit 130 controls the operation mode of the volatile memory 30 based on the memory region allocation information 142. The device operation mode control unit 160 instructs the power control circuit 70 to control the operation mode of each device based on the device operation mode information 141.

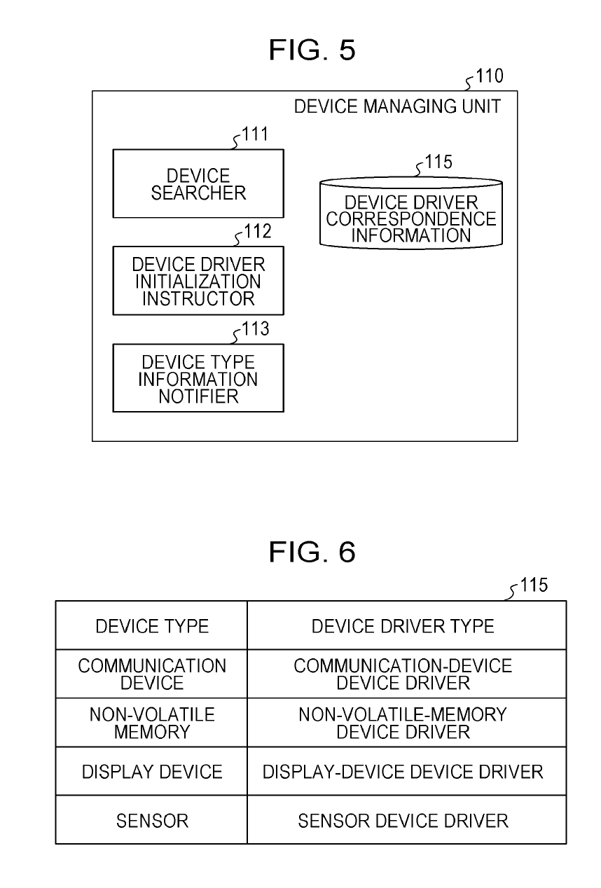

FIG. 5 is a more detailed functional block diagram of the device managing unit 110. The device managing unit 110 functions as a device searcher 111, a device driver initialization instructor 112, and a device type information notifier 113, and holds device driver correspondence information 115. FIG. 6 illustrates an example content of the device driver correspondence information 115. As illustrated in FIG. 6, the device driver correspondence information 115 indicates the type of a device, the type of a device driver, and a correspondence relation therebetween, and defines the following: a device driver of the communication device 20 is the communication-device device driver 151, a device driver of the sensor 50 is the sensor device driver 152, a device driver of the non-volatile memory 40 is the non-volatile-memory device driver 153, and a device driver of the display device 60 is the display-device device driver 154. In FIG. 5, the device searcher 111 searches for a device included in the communication terminal apparatus 1. In the present embodiment, the device searched by the device searcher 111 is the communication device 20, the non-volatile memory 40, the sensor 50, or the display device 60. The device driver initialization instructor 112 instructs the device driver corresponding to the searched device to perform an initialization. Specifically, the device driver initialization instructor 112 recognizes the device driver corresponding to the searched device by referring to the device driver correspondence information 115. Then, the device driver initialization instructor 112 instructs the device driver corresponding to the searched device to perform an initialization. The device type information notifier 113 notifies, of the type information of the device, the corresponding one of the interfaces 121A, 121B, 121C, and 121D provided to the memory managing unit 120 so as to receive a memory region acquisition request from the device driver. For example, the memory managing unit 120 notifies the interface 121A that the device driver corresponding to the interface 121A is the device driver corresponding to the communication device 20.

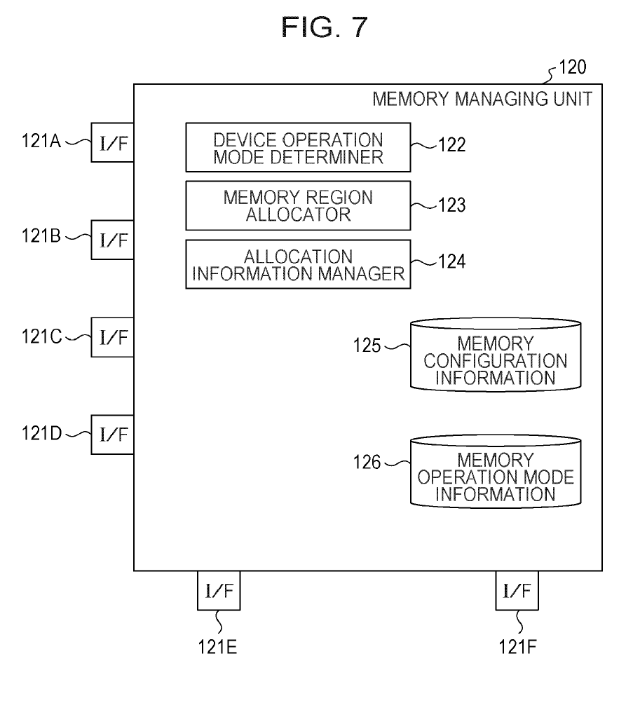

FIG. 7 is a more detailed functional block diagram of the memory managing unit 120. The memory managing unit 120 functions as a device operation mode determiner 122, a memory region allocator 123, and an allocation information manager 124. The memory managing unit 120 holds memory configuration information 125 and memory operation mode information 126. The memory managing unit 120 is provided with the interfaces 121A, 121B, 121C, 121D, 121E, and 121F. These interfaces are individually provided for the device drivers, the kernel module 155, and the app 200. As illustrated in FIG. 4, the interface 121A corresponds to the communication-device device driver 151, the interface 121B corresponds to the sensor device driver 152, the interface 121C corresponds to the non-volatile-memory device driver 153, the interface 121D corresponds to the display-device device driver 154, the interface 121E corresponds to the kernel module 155, and the interface 121F corresponds to the app 200. This correspondence relation may be defined in source codes at designing of the kernel. The interfaces 121A, 121B, 121C, and 121D are each notified, from the device type information notifier 113 of the device managing unit 110 described above, of the type information of the device corresponding to a device driver associated with itself, and store the type information of the device. The device operation mode determiner 122 determines, based on the type information of the device stored in each interface and the device operation mode information 141, an operation mode in which the device corresponding to a device driver connected with the interface is controlled in a period in which the processor 10 operates in the low-voltage mode.

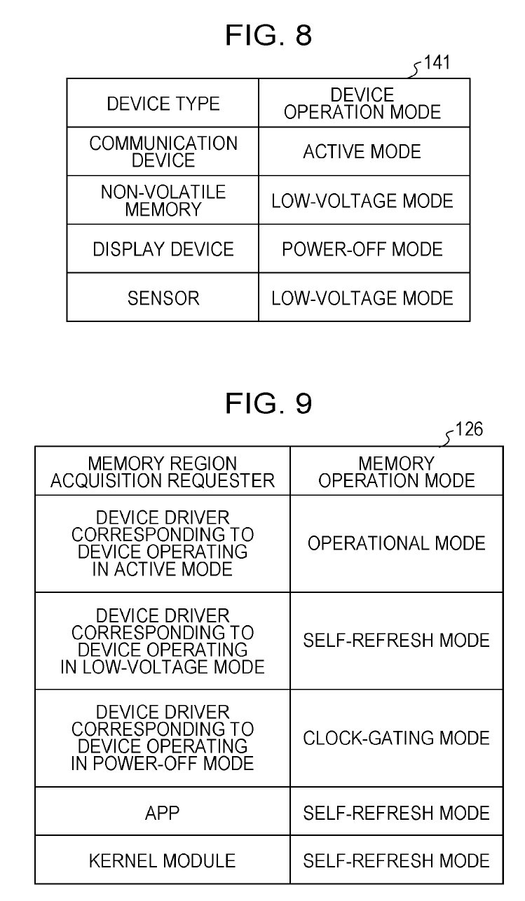

FIG. 8 illustrates an example of the device operation mode information 141. The device operation mode information 141 indicates the type information of the device, and an operation mode in which the device is controlled in a period the processor 10 is in the low-voltage mode. FIG. 8 defines that the communication device 20 is controlled in the active mode in a period in which the processor 10 operates in the low-voltage mode. In addition, FIG. 8 defines that the non-volatile memory 40, the display device 60, and the sensor 50 are operated in the low-voltage mode, the power-off mode, and the low-voltage mode, respectively, in a period in which the processor 10 operates in the low-voltage mode. The content illustrated in FIG. 8 is an example operation mode of each device, and thus another operation mode may be defined.

In FIG. 7, the memory region allocator 123 allocates a predetermined memory region of a memory space included in the volatile memory 30 in response to a memory region acquisition request received through each interface. In this memory region allocation, the memory region allocator 123 refers to the memory operation mode information 126. FIG. 9 illustrates an example of the memory operation mode information 126. The memory operation mode information 126 defines a correspondence relation between the requester of the memory region acquisition request and the operation mode of a memory region allocated in response to this request. According to FIG. 9, when the memory region acquisition requester is “the device driver corresponding to a device controlled in the active mode in a period in which the processor 10 operates in the low-voltage mode”, a memory region used by the device corresponding to this device driver is controlled in “the operational mode” in a period in which the processor 10 operates in the low-voltage mode. Similarly, when the memory region acquisition requester is “the device driver corresponding to a device controlled in the low-voltage mode in this period in which the processor 10 operates in the low-voltage mode”, a memory region used by the device corresponding to this device driver is controlled in “the self-refresh mode” in this period in which the processor 10 operates in the low-voltage mode. When the memory region acquisition requester is “the device driver corresponding to a device controlled in the power-off mode in a period in which the processor 10 operates in the low-voltage mode”, a memory region used by the device corresponding to this device driver is controlled in “the clock gating mode” in this period in which the processor 10 operates in the low-voltage mode. In addition, the memory operation mode information 126 defines a memory region allocation when the memory region acquisition request is issued from a device other than the device drivers. Specifically, the memory operation mode information 126 indicates that, when the memory region acquisition requester is “the app 200” or “the kernel module 155”, a memory region used by the app 200 or the kernel module 155 is controlled in “the self-refresh mode” in a period in which the processor 10 operates in the low-voltage mode.

In FIG. 7, the memory region allocator 123 performs, based on description of the memory operation mode information 126, a memory region allocation with taken into account a memory operation mode in response to a memory region acquisition request. For example, the memory region allocator 123 allocates a first memory region to a memory region acquisition requester of which corresponding memory operation mode is “the operational mode”, allocates a second memory region to a memory region acquisition requester of which corresponding memory operation mode is “the self-refresh mode”, and allocates a third memory region to a memory region acquisition requester of which corresponding memory operation mode is “the clock gating mode”. In this manner, the memory region allocator 123 allocates different memory regions depending on the attribute of a memory region acquisition requestor. In particular, when the memory region acquisition requester is a device driver, the memory region allocator 123 allocates a memory region depending on an operation mode in which the device corresponding to the device driver is controlled in a period in which the processor 10 operates in the low-voltage mode. Accordingly, when the processor 10 operates in the low-voltage mode, a particular device may be selectively controlled in the active mode, and a memory region used by this device may be selectively controlled in the operational mode. When the processor 10 operates in the low-voltage mode, a memory region used by another device controlled in the low-voltage mode or the power-off mode may be controlled in the self-refresh mode or the clock gating mode, thereby achieving a reduced electrical power consumption of the communication terminal apparatus 1. A specific method of controlling different memory regions included in the volatile memory 30 in different operation modes is described later.

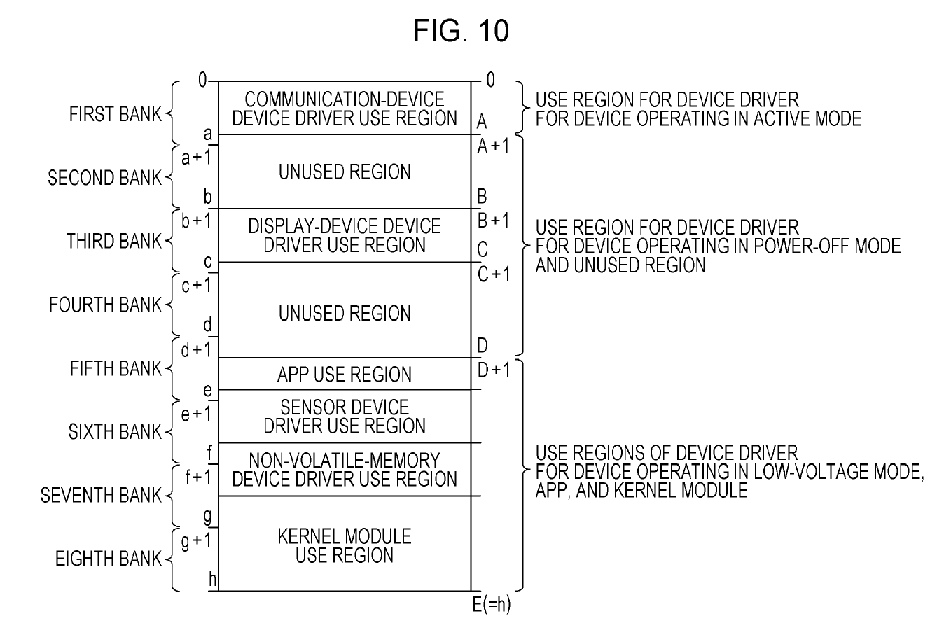

FIG. 10 illustrates an address space of the volatile memory 30 and example memory regions allocated to the device drivers, the kernel module 155, and the app 200. Description is made of a DRAM including eight banks as an example of the volatile memory 30. Regions of which memory addresses are from 0 to a, from a+1 to b, from b+1 to c, from c+1 to d, from d+1 to e, from e+1 to f, from f+1 to g, and from g+1 to h correspond to first to eighth banks, respectively. In the volatile memory 30 having such a configuration, a memory region having an address of 0 to A (A≦a) is allocated in response to a memory region acquisition request by the communication-device device driver 151. A memory region having a memory address of B+1 to C (B=b and C≦c) is allocated in response to a memory region acquisition request by the display-device device driver 154. A memory region having a memory address of D+1 to E (D≧d and E=h) is allocated in response to a memory region acquisition request by the sensor device driver 152, the non-volatile-memory device driver 153, the kernel module 155, and the app 200. In this manner, in response to a memory region acquisition request, the memory managing unit 120 categorizes a memory region based on the attribute (operation mode in which, when the memory region acquisition requester is a device driver, the device corresponding to the device driver is controlled in a period in which the processor 10 operates in the active mode) of the memory region acquisition requestor thereof.

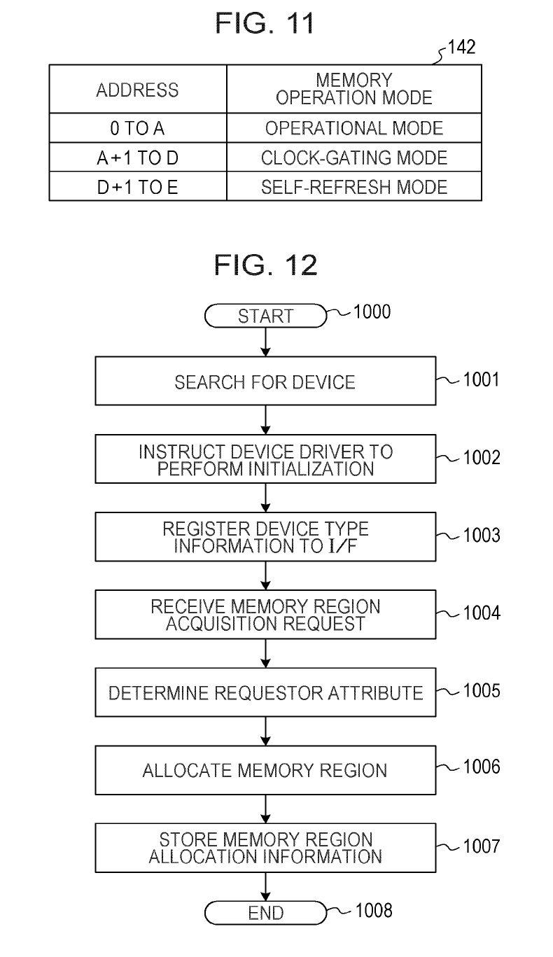

FIG. 11 illustrates a content of the memory region allocation information 142. Having performed a memory region allocation, the memory managing unit 120 produces the memory region allocation information 142 as a result. The memory region allocation information 142 defines an address in the volatile memory 30 and an operation mode in which the memory region corresponding to the address is controlled when the processor 10 operates in the low-voltage mode. The first line in the memory region allocation information 142 defines that, when the processor 10 operates in the low-voltage mode, a memory region having an address of 0 to A is controlled in “the operational mode”. In other words, this memory region is accessible when the processor 10 operates in the low-voltage mode. The second line in the memory region allocation information 142 defines that, when the processor 10 operates in the low-voltage mode, a memory region having an address of A+1 to D is controlled in “the clock gating mode”. In other words, this memory region is not accessible in a period in which the processor 10 operates in the low-voltage mode. The third line in the memory region allocation information 142 defines that, when the processor 10 operates in the low-voltage mode, a memory region having an address of D+1 to E is controlled in “the self-refresh mode”. In other words, this memory region is not accessible but data previously stored in this memory region is held in a period in which the processor 10 operates in the low-voltage mode.

FIG. 12 illustrates the process of a memory region allocation. The process of a memory region allocation is started at processing 1000, and then the device searcher 111 searches for a device included in the communication terminal apparatus 1 at processing 1001. At processing 1002, the device driver initialization instructor 112 specifies the device driver corresponding to the device thus searched at processing 1001 by referring to the device driver correspondence information 115, and instructs the device driver thus specified to perform an initialization. At processing 1003, the device type information notifier 113 registers the type information of the device searched at processing 1001 to the interfaces 121A to 121D of the memory managing unit 120 by referring to the device driver correspondence information 115. At processing 1004, the interfaces 121A to 121F receives a memory region acquisition request. At processing 1005, the memory region allocator 123 determines the attribute of the requestor of the memory region acquisition request received at processing 1004. The determination of the attribute of the requestor is determination of whether the requester is the app 200, the kernel module 155, or a device driver, and if the requester is a device driver, determination of whether the operation mode of the device corresponding to the device driver is the active mode, the low-voltage mode, or the power-off mode. Next at processing 1006, the memory region allocator 123 performs a memory region allocation based on the device operation mode information 141 in response to the memory region acquisition request received at processing 1004. Then, at processing 1007, the allocation information manager 124 stores a result of this memory region allocation in the memory region allocation information 142, and then the process ends at processing 1008.

The above describes the procedure of allocating a memory region based on the attribute of the requestor of a memory region acquisition request. Next follows a description of a method of switching the operation mode of each device when the processor 10 shifts from the active mode to the low-voltage mode, and further controlling the volatile memory 30 based on the memory region allocation information 142.

As illustrated in FIG. 4, the device operation mode information 141 stores information defining the operation mode of each device when the processor 10 operates in the low-voltage mode. The memory region allocation information 142 stores a result of a memory region allocation performed by the memory managing unit 120 in response to a memory region acquisition request. The device operation mode control unit 160 and the memory operation mode control unit 130 control the power control circuit 70 and the volatile memory 30 based on the device operation mode information 141 and the memory region allocation information 142, respectively.

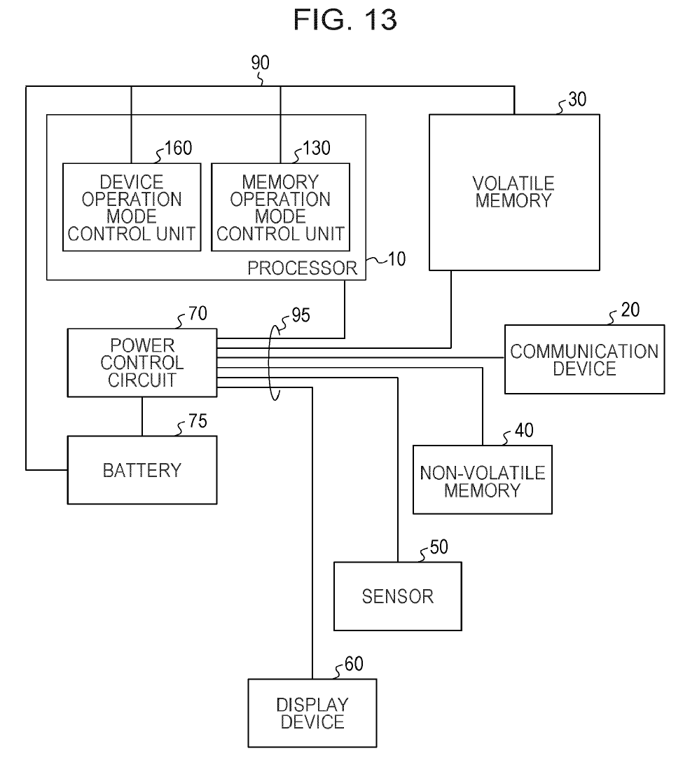

FIG. 13 illustrates a connection relation between the processor 10, the power control circuit 70, and the volatile memory 30. The processor 10 is connected with the power control circuit 70 through the bus 90, and the device operation mode control unit 160 of the processor 10 controls the power control circuit 70 through the bus 90. The processor 10 is also connected with the volatile memory 30 through the bus 90, and the memory operation mode control unit 130 of the processor 10 transmits a command to the volatile memory 30 to control the operation mode of the volatile memory 30. The power control circuit 70 is connected with the processor 10 and the volatile memory 30 through a power supply line 95. FIG. 13 also illustrates the battery 75 connected with the power control circuit 70, and the communication device 20, the non-volatile memory 40, the sensor 50, and the display device 60 that are connected with the power control circuit 70 through the power supply line 95.

The device operation mode control unit 160 instructs the power control circuit 70 to switch the operation mode of each device in accordance with the definition content of the device operation mode information 141. In the present embodiment, as illustrated in FIG. 8, the operation mode of the communication device 20 is defined to be “the active mode”. Accordingly, the device operation mode control unit 160 instructs the power control circuit 70 to maintain, at a normal potential, the potential of the power supply line 95 connected with the communication device 20 so that the communication device 20 may perform a normal operation in a period in which the processor 10 is controlled in the low-voltage mode. As illustrated in FIG. 8, the operation modes of the non-volatile memory 40 and the sensor 50 are defined to be “the low-voltage mode”. Accordingly, the device operation mode control unit 160 instructs the power control circuit 70 to switch a potential provided to the non-volatile memory 40 and the sensor 50 to a potential lower than a normal voltage in the period in which the processor 10 is controlled in the low-voltage mode. As illustrated in FIG. 8, the operation mode of the display device 60 is defined to be “the power-off mode”. Accordingly, the device operation mode control unit 160 instructs the power control circuit 70 to stop an electrical power supplied to the display device 60 in the period in which the processor 10 is controlled in the low-voltage mode. In this manner, an appropriate electrical power consumption of each device is set.

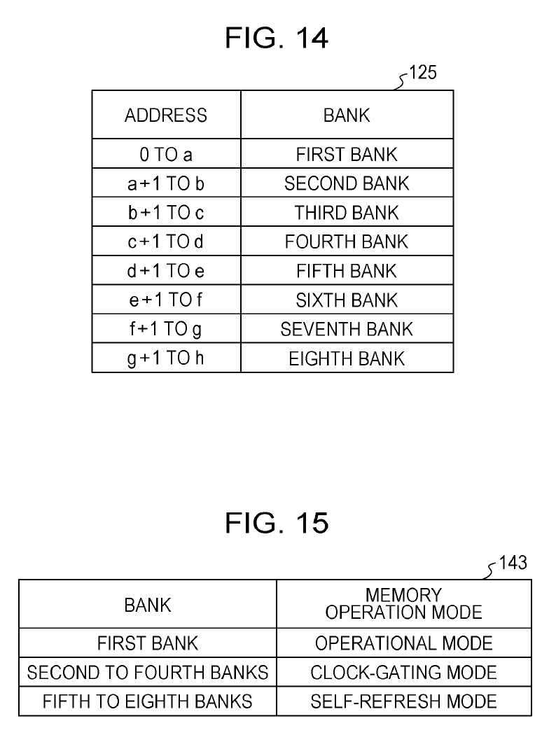

Next follows a description of a method of controlling the operation mode of the volatile memory 30. FIG. 14 illustrates the memory configuration information 125 indicating a correspondence relation between addresses and banks of the volatile memory 30, and the memory configuration information 125 is held by, for example, the memory managing unit 120. The memory operation mode control unit 130 specifies, among the banks included in the volatile memory 30 by referring to the memory configuration information 125 and the memory region allocation information 142 illustrated in FIG. 11, a bank controlled in the operational mode, a bank controlled in the self-refresh mode, and a bank controlled in the clock gating mode. FIG. 15 illustrates the content of bank control information 143 indicating banks controlled in the operation modes specified by the memory operation mode control unit 130. The bank control information 143 is held in, for example, the memory operation mode control unit 130. As defined in FIG. 15, the first bank is controlled in the operational mode, the second to fourth banks are controlled in the clock gating mode, and the fifth to eighth banks are controlled in the self-refresh mode. Subsequently, based on the bank control information 143 illustrated in FIG. 15, the memory operation mode control unit 130 transmits, to the volatile memory 30, a command indicating an operation mode in which each bank is controlled. Based on this command, the volatile memory 30 switches the operation mode for each bank and operates. Specifically, the volatile memory 30 selectively controls, in the operational mode, a bank including a memory region used by a device that maintains the active mode in a period in which the processor 10 operates in the low-voltage mode. The volatile memory 30 also selectively controls, in the self-refresh mode, a bank including a memory region used by a device controlled in the low-voltage mode in a period in which the processor 10 operates in the low-voltage mode. The volatile memory 30 selectively controls, in the clock gating mode, a bank including a memory region used by a device controlled in the power-off mode in a period in which the processor 10 operates in the low-voltage mode.

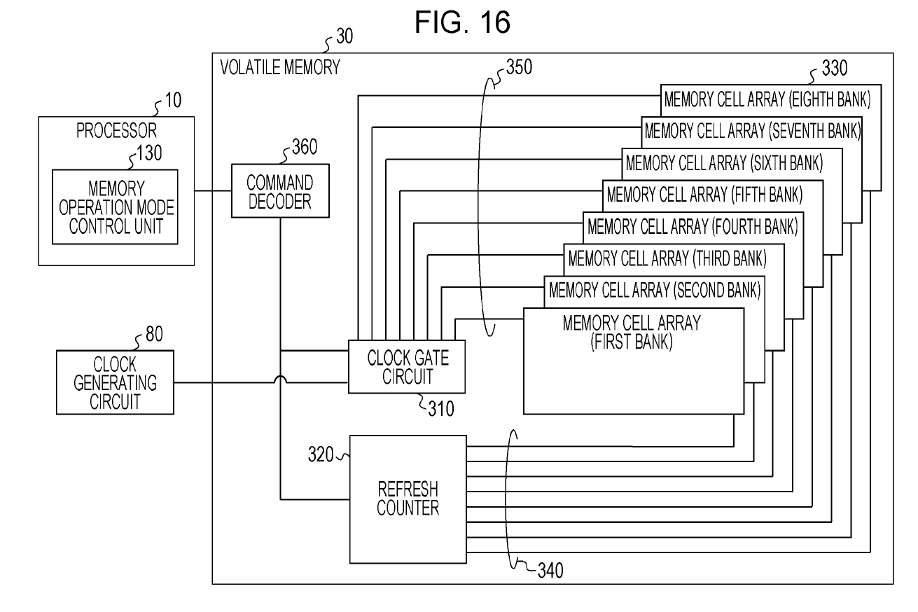

Next follows a description of the configuration of the volatile memory 30 with reference to FIG. 16. the volatile memory 30 includes a command decoder 360 that receives a command transmitted from the processor 10, and a clock gate circuit 310 that receives a clock supplied from the clock generating circuit 80. The volatile memory 30 further includes a refresh counter 320 that generates an internal clock determining a time interval to perform self-refresh, and eight memory cell arrays 330 corresponding to the first to eighth banks, respectively. The clock gate circuit 310 and each memory cell array 330 are connected with each other through a clock supply line 350, and the refresh counter 320 and each memory cell array 330 are connected with each other through an internal clock supply line 340.

The command decoder 360 instructs, based on a command received from the memory operation mode control unit 130, the clock gate circuit 310 about the memory cell array 330 to which a clock is to be supplied. In accordance with this instruction from the command decoder 360, the clock gate circuit 310 supplies a clock to a particular memory cell array 330, in other words, the memory cell array 330 corresponding to the first bank of which memory operation mode is specified to be the operational mode by the bank control information 143, and stops clock supply to other memory cell arrays 330. The command decoder 360 instructs, based on a command received from the memory operation mode control unit 130, the refresh counter 320 to which memory cell array 330 an internal clock is to be supplied. In accordance with this instruction from the command decoder 360, the refresh counter 320 selectively supplies an internal clock to a particular memory cell array 330, in other words, the memory cell arrays 330 corresponding to the fifth to eighth banks of which memory operation modes are specified to be the self-refresh mode by the bank control information 143. This control allows for selection of an operation mode for each bank included in the volatile memory 30, thereby achieving a reduced electrical power consumption of the volatile memory 30. FIG. 16 illustrates the DRAM including a plurality of banks as an example of the volatile memory 30, but the present embodiment is not limited to a configuration including such a DRAM. For example, the present disclosure is also applicable to such a DRAM configuration that a plurality of different semiconductor chips are modularized as a single memory package and an operation mode is switched for each semiconductor chip.

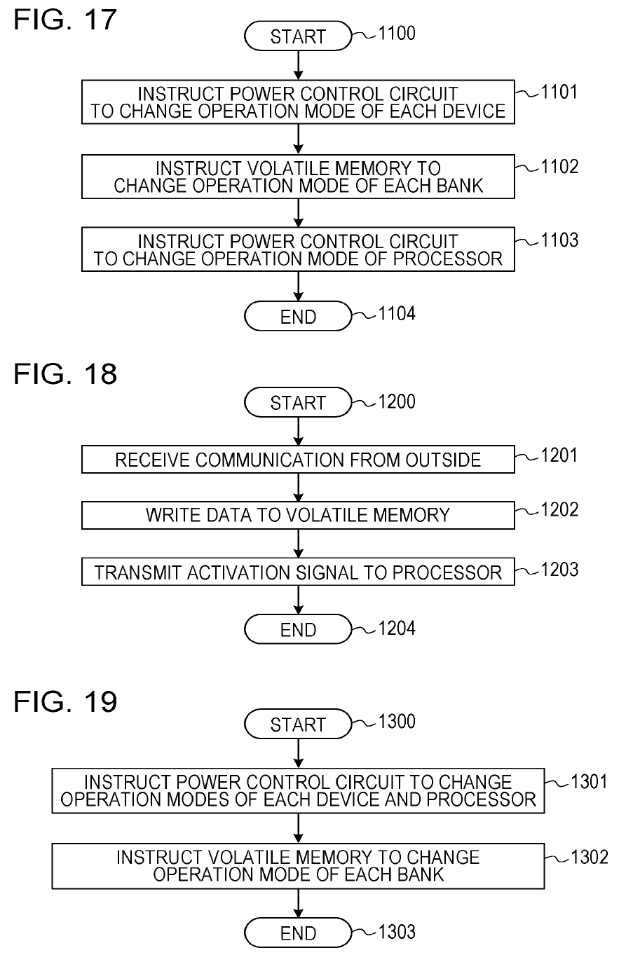

FIG. 17 illustrates the process of a shift of the processor 10 from the active mode to the low-voltage mode. The process of this mode shift is started at processing 1100, and then the device operation mode control unit 160 instructs, by referring to the device operation mode information 141, the power control circuit 70 to change the operation mode of each device at processing 1101. Specifically, the device operation mode control unit 160 transmits, to the power control circuit 70 through the bus 90, an instruction to set the potential of the power supply line 95 connected with the communication device 20 to a normal potential, the potential of the power supply line 95 connected with the non-volatile memory 40 and the sensor 50 to a low potential, and to stop electrical power supply to the power supply line 95 connected with the display device 60. At processing 1102, the memory operation mode control unit 130 instructs the volatile memory 30 to change the operation mode of each bank. Specifically, the memory operation mode control unit 130 gives an instruction to supply a clock to the first bank, stop clock supply to the second to fourth banks, and stop clock supply but supply an internal clock to the fifth to eighth banks to perform self-refresh. At processing 1103, the device operation mode control unit 160 instructs the power control circuit 70 to change the operation mode of the processor 10. Specifically, the device operation mode control unit 160 transmits, to the power control circuit 70 through the bus 90, an instruction to set the potential of the power supply line 95 connected with the processor 10 to a low potential.

Through the process described above, the processor 10 shifts from the active mode to the low-voltage mode, while a device such as the communication device 20 that receives an activation event maintains the active mode. Devices such as the sensor 50 and the non-volatile memory 40 shift to the low-voltage mode, and the display device 60 shifts to the power-off mode, thereby achieving a reduced electrical power consumed by the devices. Controlling, in the operational mode, a bank including a memory region used by a device that maintains the active mode allows for an access to the volatile memory 30 from a device that operates in the active mode. Controlling, in the self-refresh mode, a bank including a memory region used by a device controlled in the low-voltage mode, achieves a reduced electrical power consumption of the volatile memory 30 while inhibiting deletion of data held by this bank. Controlling, in the clock gating mode, a bank including a memory region used by a device controlled in the power-off mode, achieves a further reduced electrical power consumption of the volatile memory 30.

Next follows a description of processing to be performed when the communication device 20 receives an activation event from, for example, another communication terminal device and activates the processor 10 in a period in which the processor 10 operates in the low-voltage mode. FIG. 18 illustrates a process executed by the communication device 20. The process by the communication device 20 is started at processing 1200, and then the communication device 20 receives an activation event from outside at processing 1201. At processing 1202, the communication device 20 writes desired data related to the activation event thus received in an allocated memory region of the volatile memory 30. At processing 1203, the communication device 20 transmits an activation signal to the processor 10, and then the process ends at processing 1204.

Next follows a description of the process of an activation performed by the processor 10 having received the activation signal from the communication device 20 with reference to FIG. 19. The process of an activation executed by the processor 10 is started at processing 1300, and then the device operation mode control unit 160 instructs the power control circuit 70 to change the operation modes of each device and the processor 10 at processing 1301. At processing 1302, the memory operation mode control unit 130 instructs the volatile memory 30 to change the operation mode of each bank. Thereafter, the process ends at processing 1303.

The above description is made on the first embodiment. The first embodiment describes the example in which the device managing unit 110 registers the type information of a device to the interfaces 121A to 121D. In an alternative method, the device managing unit 110 may register information of the operation mode of a device to the interfaces 121A to 121D by referring to the device operation mode information 141. In this method, having received a memory region acquisition request, the memory managing unit 120 may perform a memory region allocation without access to the device operation mode information 141.

### Second Embodiment

In the first embodiment, the devices included in the communication terminal apparatus 1 are fixed, and a correspondence relation between the device drivers and the interfaces 121A to 121D provided to the memory managing unit 120 is defined at designing of the kernel. The second embodiment describes a case in which devices dynamically change, in other words, a device driver is newly connected with the memory managing unit 120 or disconnected from the memory managing unit 120. Those applicable in the second embodiment among the hardware and functional blocks described in the first embodiment are denoted by the same reference numerals, and descriptions thereof are omitted as appropriate.

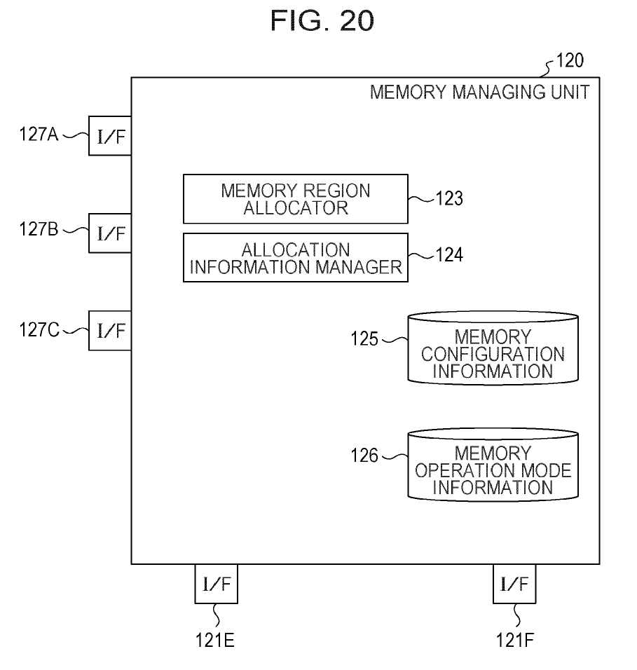

FIG. 20 is a block diagram of the memory managing unit 120 according to the second embodiment. The memory managing unit 120 according to the second embodiment includes interfaces 127A, 127B, and 127C as interfaces for device drivers. The interface 127A is provided for any device driver corresponding to a device that operates in the active mode when the processor 10 operates in the low-voltage mode as a standby mode. The interface 127B is provided for any device driver corresponding to a device that operates in the low-voltage mode when the processor 10 operates in the low-voltage mode interface. The interface 127C is provided for any device driver corresponding to a device that operates in the power-off mode when the processor 10 operates in the low-voltage mode. In response to a memory region allocation request received through the interface 127A, the memory region allocator 123 allocates a memory region controlled in the operational mode when the processor 10 operates in the low-voltage mode. In response to a memory region allocation request received through the interface 127B, the memory region allocator 123 allocates a memory region controlled in the self-refresh mode when the processor 10 operates in the low-voltage mode. In response to a memory region allocation request received through the interface 127C, the memory region allocator 123 allocates a memory region controlled in the clock gating mode when the processor 10 operates in the low-voltage mode.

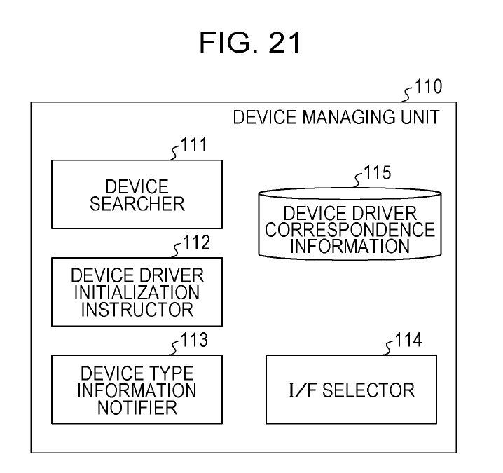

FIG. 21 is a block diagram of the device managing unit 110 according to the second embodiment. The device managing unit 110 includes an interface selector 114. When the communication terminal apparatus 1 is newly connected with an external device, the device searcher 111 executes a search for the device. Then, the device searcher 11 downloads the device driver corresponding to this newly connected device. Thereafter, the device driver initialization instructor 112 instructs the device driver corresponding to the newly connected device to perform an initialization. The interface selector 114 determines, by referring to the device operation mode information 141, an operation mode in which the newly connected device operates when the processor 10 operates in the low-voltage mode. If the operation mode is determined to be the active mode, the interface selector 114 associates the corresponding device driver with the interface 127A. If the operation mode is determined to be the low-voltage mode, the interface selector 114 associates the corresponding device driver with the interface 127B. If the operation mode is determined to be the power-off mode, the interface selector 114 associates the corresponding device driver with the interface 127C. When the communication terminal apparatus 1 cancels the connection of the newly connected device, a correspondence relation between the device driver and the interface corresponding to the device driver is canceled.

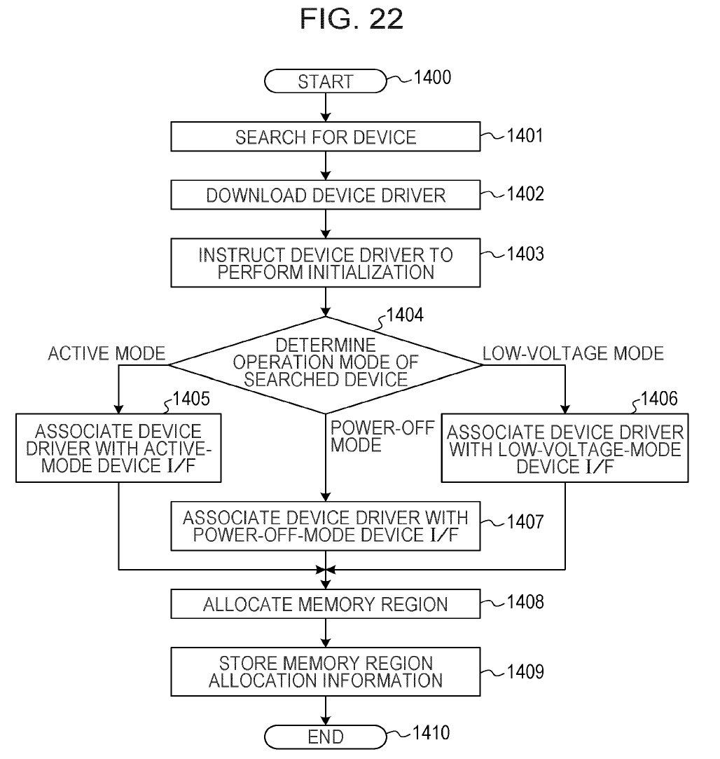

FIG. 22 illustrates the process of a memory region allocation. The process of this memory region allocation is started at processing 1400, and then the device searcher 111 searches for a device newly connected with the communication terminal apparatus 1 at processing 1401. At processing 1402, the device searcher 111 downloads the device driver corresponding to the searched device. At processing 1403, the device driver initialization instructor 112 instructs the device driver corresponding to the newly connected device to perform an initialization. At processing 1404, the interface selector 114 determines, by referring to the device operation mode information 141, an operation mode in which the newly searched device is controlled when the processor 10 operates in the low-voltage mode. If the determination at processing 1404 indicates that the operation mode is the active mode, the interface selector 114 associates the device driver with the interface 127A at processing 1405. If the determination at processing 1404 indicates that the operation mode is the low-voltage mode, the interface selector 114 associates the device driver with the interface 127B at processing 1406. If the determination at processing 1404 indicates that the operation mode is the power-off mode, the interface selector 114 associates the device driver with the interface 127C at processing 1407. At processing 1408, the memory region allocator 123 performs a memory region allocation in response to a received memory region acquisition request. In this processing, the memory region allocator 123 performs the memory region allocation with taken into account which of the interfaces 127A, 127B, and 127C has received the memory region acquisition request. Thereafter, the allocation information manager 124 stores a result of the memory region allocation in the memory region allocation information 142 at processing 1409, and then the process ends at processing 1410.

As described above, in the second embodiment, the memory managing unit 120 is provided with an interface dedicated to the operation mode of a device, and an interface to be connected with the device driver corresponding to a newly connected device is selected based on the operation mode of the device. Accordingly, the memory managing unit 120 may perform an appropriate memory region allocation in response to a memory region acquisition request from the device driver. Similarly to the first embodiment, a particular region of the volatile memory 30 may be selectively controlled in the operational mode, the self-refresh mode, or the clock gating mode.

The second embodiment describes the case in which the communication terminal apparatus 1 is newly connected with a device. Connection meant by the wording of “connected with a device” is not limited to wired connection but includes wireless connection.

### Third Embodiment

In the first and second embodiments, for example, the communication device 20 is defined as a device that maintains the active mode when the processor 10 operates in the low-voltage mode. However, a mode in which a device is controlled when the processor 10 operates in the low-voltage mode may dynamically change among the active mode, the low-voltage mode, and the power-off mode. For example, such a case is assumed that the app 200 requests reception of a notification when the communication device 20 receives a particular activation event. In this case, when a user of the communication terminal apparatus 1 determines that a function of the app 200 is not to be used and stops the app 200, the communication device 20 does not have to be maintained in the active mode. In such a case, the communication device 20 is shifted to the low-voltage mode or the power-off mode, and a memory region allocated to the communication device 20 is shifted to a region controlled in the self-refresh mode or the clock gating mode. In contrast, when the app 200 is started up, the communication device 20 is shifted to the active mode, and a memory region allocated to the communication device 20 is shifted to a region controlled in the operational mode. The third embodiment describes a control method in such a case.

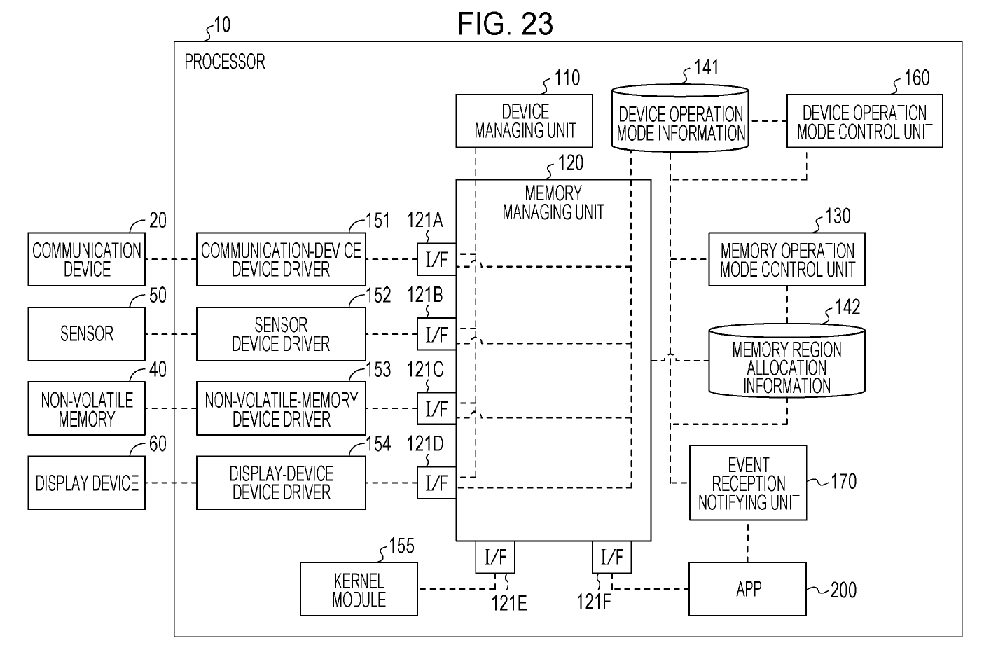

FIG. 23 illustrates a relation between functional blocks achieved by the processor 10 according to the third embodiment and the devices included in the communication terminal apparatus 1. The following describes any function different from the functions of the processor 10 described in the first embodiment with reference to FIG. 4. The processor 10 functions as an event reception notifying unit 170 in addition to the functions illustrated in FIG. 4. The event reception notifying unit 170 receives, from the app 200, a request to transmit a notification when an event occurs. The event reception notifying unit 170 determines whether the event specified from the app 200 is of a kind to be detected by using any device included in the communication terminal apparatus 1. If this event is of the kind to be detected by using any device included in the communication terminal apparatus 1, the event reception notifying unit 170 further determines whether there is a possibility that this device generates an activation signal to shift the processor 10 operating in the low-voltage mode to the active mode. There is a possibility that this device generates the activation signal to the processor 10, if this device has to be maintained in the active mode in a period in which the processor 10 operates in the low-voltage mode. If there is a possibility that this device generates the activation signal, the event reception notifying unit 170 accesses the device operation mode information 141 to define the operation mode of this device to be “the active mode”. In contrast, if the app 200 is stopped and this device no longer has to be maintained in the active mode, the event reception notifying unit 170 accesses the device operation mode information 141 to define the operation mode of this device to be a “low electrical power mode” or “the power-off mode”.

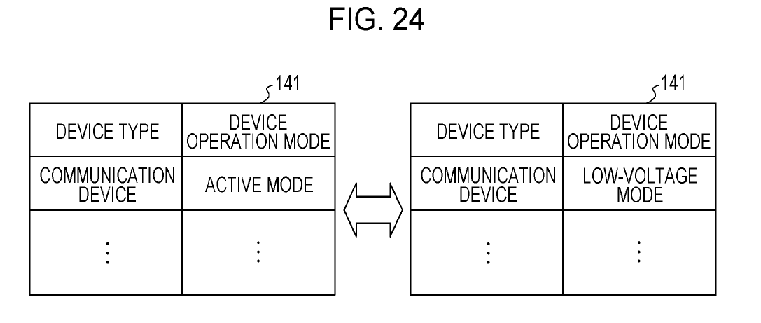

FIG. 24 illustrates an example change in description of the device operation mode information 141. In this example, the operation mode of the communication device 20 is defined to be “the active mode” when the app 200 using the communication device 20 functions, and “the low-voltage mode” when the app 200 is stopped.

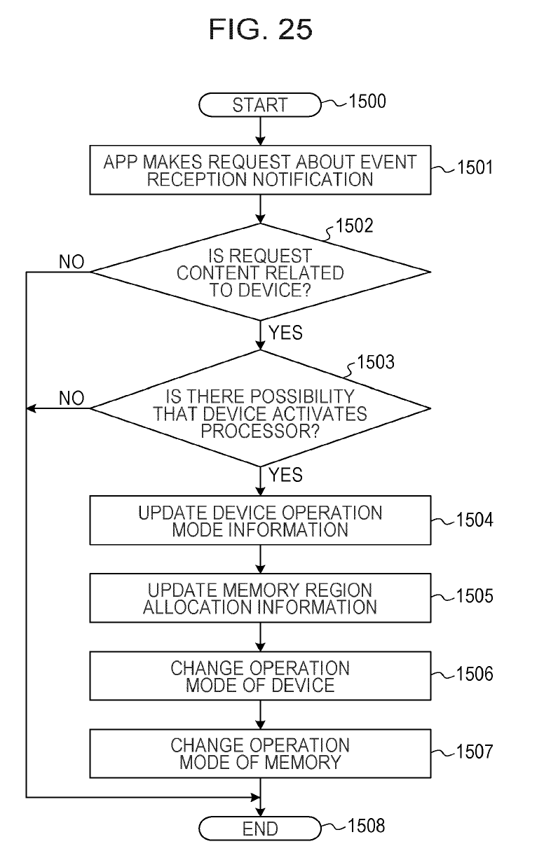

FIG. 25 illustrates the process of an operation mode change according to the third embodiment. The process of this operation mode change is started at processing 1500, and then at processing 1501, the app 200 requests the event reception notifying unit 170 to deliver an event reception notification when a particular event is received. At processing 1502, the event reception notifying unit 170 determines whether a particular event is related to a device of the communication terminal apparatus 1. At processing 1502, the process proceeds to processing 1508 if the particular event is determined not to be related to the device, and proceeds to processing 1503 if the particular event is determined to be related to the device. At processing 1503, the event reception notifying unit 170 determines whether there is a possibility that the device related to the particular event issues an activation signal to the processor 10 operating in the low-voltage mode. At processing 1503, the process proceeds to processing 1508 if it is determined that there is no possibility that the device issues an activation signal, and proceeds to processing 1504 if it is determined that there is a possibility that the device issues an activation signal. At processing 1504, the event reception notifying unit 170 changes the content of the device operation mode information 141, and registers to the device operation mode information 141 that the operation mode of the device is the active mode. At processing 1505, the event reception notifying unit 170 changes the content of the memory region allocation information 142 to the active mode in response to the change of the operation mode of the device. Then, at processing 1506, the device operation mode control unit 160 changes the operation mode of the device in accordance with the changed content of the device operation mode information 141. At processing 1507, the memory operation mode control unit 130 changes the operation mode of the volatile memory 30 in accordance with the changed content of the memory region allocation information 142, and then the process ends at processing 1508. Although FIG. 25 illustrates the case in which the operation mode of a device is changed to the active mode in the device operation mode information 141, the same process is applied when the operation mode of a device in the device operation mode information 141 is changed from the active mode to another mode. In this case, the app 200 requests stop of the delivery of an event reception notification at processing 1501. Then, at processing 1504, the event reception notifying unit 170 registers to the device operation mode information 141 that the operation mode of the device related to the particular event is the active mode.

The above-described processing achieves a reduced electrical power consumption of a device and the volatile memory 30 in a case in which the operation mode of the device when the processor 10 operates in the low-voltage mode is changed.

### Fourth Embodiment

The first to third embodiments describe the case in which the volatile memory 30 stores data desired for operations of the processor 10 and the devices. The fourth embodiment describes a case in which a magnetoresistive memory or a ferroelectric memory is used in place of the volatile memory 30. A magnetoresistive random access memory (MRAM) and a ferroelectric random access memory (FeRAM) are each a memory capable of holding data even when power supply thereto is cut. When used in place of the volatile memory 30, the MRAM or the FeRAM may hold previously stored data without using the self-refresh mode as described in the first to third embodiments. Accordingly, the fifth to eighth banks do not have to be controlled in the self-refresh mode as described in the first to third embodiments. Accordingly, a reduced electrical power consumption of the volatile memory 30 is achieved. In the fourth embodiment, the operation mode of “the driver corresponding to a device that operates in the low-voltage mode” in the memory operation mode information 126 illustrated in FIG. 9 is changed from “the self-refresh mode” to “the clock gating mode”. Accordingly, the operation modes of the fifth to eighth banks in the bank control information 143 illustrated in FIG. 15 are changed from “the self-refresh mode” to “the clock gating mode”, thereby achieving a reduced electrical power consumption of the volatile memory 30.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An electronic apparatus comprising:
a memory;
a first device; and
a processor that operates in an active mode and a standby mode with which an electrical power consumption is lower than an electrical power consumption of the active mode, the processor being configured to
determine whether the first device is of a first type that operates in a period in which the processor is in the standby mode,
allocate a first region of the memory as a region used by the first device when the first device is determined to be of the first type, and
control, in a period in which the processor operates in the standby mode, the first region to be operated in a first mode and a second region of the memory other than the first region to be operated in a second mode, the first mode being a mode with which the first region is usable by the first device, and the second mode being a mode with which an electrical power consumption is lower than an electrical power consumption of the first mode.

2. The electronic apparatus according to claim 1, wherein the processor is configured to allocate the first region as a region used by the first device in response to a first request to acquire a memory region used by the first device.

3. The electronic apparatus according to claim 2, wherein the processor is configured to issue the first request by executing processing of a first device driver that controls the first device.

4. The electronic apparatus according to claim 1, wherein
the first device is a communication device and is configured to receive a signal from another electronic apparatus in a period in which the processor is in the standby mode, and
the processor is configured to transit into the active mode upon reception of the signal.

5. The electronic apparatus according to claim 4, wherein
the first device is configured to
write data into the first region of the memory in accordance with receiving the signal, and
transmit an activation signal to the processor.

6. The electronic apparatus according to claim 3, wherein the processor is configured to execute kernel processing including
processing of the first device driver,
processing of allocating the first region of the memory in response to the first request, and
processing of searching for the first device.

7. The electronic apparatus according to claim 1, further comprising a second device that operates in an active mode and a low electrical power consumption mode having an electrical power consumption lower than an electrical power consumption of the active mode, wherein
the processor is configured to
determine whether the second device is of a second type that operates in the low electrical power consumption mode in a period in which the processor is in the standby mode, and
allocate the second region of the memory as a region used by the second device when the second device is of the second type.

8. The electronic apparatus according to claim 1, wherein the memory is a volatile memory.

9. The electronic apparatus according to claim 8, wherein the second mode is a self-refresh mode.

10. The electronic apparatus according to claim 1, wherein the memory is a magnetoresistive memory or a ferroelectric memory.

11. The electronic apparatus according to claim 1, wherein the memory includes a plurality of banks, a first bank included in the plurality of banks is controlled in the first mode, and a second bank included in the plurality of banks is controlled in the second mode.

12. A method of controlling an electronic apparatus including a memory,
a first device and a processor, the method comprising:
determining, by the processor that operates in an active mode and a standby mode with which an electrical power consumption is lower than an electrical power consumption of the active mode, whether the first device is of a first type that operates in a period in which the processor is in the standby mode;
allocating, by the processor, a first region of the memory as a region used by the first device when the first device is determined to be of the first type; and
controlling, by the processor, for a period in which the processor operates in the standby mode, the first region to be operated in a first mode and a second region of the memory other than the first region to be operated in a second mode, the first mode being a mode with which the first region is usable by the first device, and the second mode being a mode with which an electrical power consumption is lower than an electrical power consumption of the first mode.

13. The method according to claim 12, further comprising:
allocating, by the processor, the first region as a region used by the first device in response to a first request to acquire a memory region used by the first device.

14. The method according to claim 13, further comprising:
issuing, by the processor, the first request by executing processing of a first device driver that controls the first device.

15. The method according to claim 12, wherein
the first device is a communication device and is configured to receive a signal from another electronic apparatus in a period in which the processor is in the standby mode, and
the method further comprising
transiting the processor into the active mode upon reception of the signal.

16. The method according to claim 15, further comprising:
writing, by the first device, data into the first region of the memory in accordance with receiving the signal; and
transmitting, by the first device, an activation signal to the processor.

17. The method according to claim 14, further comprising:
executing, by the processor, kernel processing including
processing of the first device driver,
processing of allocating the first region of the memory in response to the first request, and
processing of searching for the first device.

18. The method according to claim 12, further comprising:
determining, by the processor, whether a second device is of a second type that operates in the low electrical power consumption mode in a period in which the processor is in the standby mode, the second device being a device that operates in an active mode and a low electrical power consumption mode having an electrical power consumption lower than an electrical power consumption of the active mode; and
allocating, by the processor, the second region of the memory as a region used by the second device when the second device is of the second type.

19. A non-transitory computer readable medium having stored therein a program that causes a computer, which includes a memory, a first device and a processor, to execute a process, the processor being operated in an active mode and a standby mode with which an electrical power consumption is lower than an electrical power consumption of the active mode, the process comprising:
determining whether the first device is of a first type that operates in a period in which the processor is in the standby mode;
allocating a first region of the memory as a region used by the first device when the first device is determined to be of the first type; and
controlling, for a period in which the processor operates in the standby mode, the first region to be operated in a first mode and a second region of the memory other than the first region to be operated in a second mode, the first mode being a mode in which the first region is usable by the first device, and the second mode being a mode with which an electrical power consumption is lower than an electrical power consumption of the first mode.
